(19) United States
(12) Patent Application Publication
(10) Pub. No.: US 2024/0126228 A1
(43) Pub. Date: Apr. 18, 2024

(54) Thermal-Aware Programmable Logic Device-Based Programming

(71) Applicants: Archanna Srinivasan, San Jose, CA (US); Teik Wah Lim, Bayan Lepas (MY); Pravin Chander Chandran, Fremont, CA (US)

(72) Inventors: Archanna Srinivasan, San Jose, CA (US); Teik Wah Lim, Bayan Lepas (MY); Pravin Chander Chandran, Fremont, CA (US)

(21) Appl. No.: 18/398,709

(22) Filed: Dec. 28, 2023

(51) Int. Cl. G05B 19/05

(52) U.S. Cl. CPC G05B 19/056; G05B 2219/13004

(57) ABSTRACT

Systems or methods of the present disclosure may provide for implementing design software that is used to design a configuration for a programmable fabric of a programmable logic device. Implementing the design software includes receiving, at a processor, design configuration details for the configuration. Implementing the design software also includes receiving, at the processor, a plurality of constraints including a thermal constraint for the configuration. Moreover, implementing the design software comprises performing thermal aware resource selection based at least in part on the thermal constraint. Furthermore, implementing the design software includes causing the programmable logic device to be operated to stay within the thermal constraint.

### BACKGROUND

The present disclosure relates generally to integrated circuit (IC) devices such as programmable logic devices (PLDs). More particularly, the present disclosure relates to techniques for programming a PLD, such as a field programmable gate array (FPGA), based at least in part on temperature.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuit devices are found in a wide variety of products, including computers, handheld devices, industrial infrastructure, televisions, and vehicles. Many of these integrated circuit devices are application-specific integrated circuit (ASICs) that are designed and manufactured to perform specific tasks or processors, such as central processing units (CPUs) or graphics processing units (GPU). A programmable logic device such as an FPGA, by contrast, may be configured after manufacturing with a variety of different system designs. As such, programmable logic devices may be used for varying tasks and/or workloads based on user-specific designs/configurations. Temperatures during operation of the PLDs may impact performance. However, due to the client-specific designs and configurations of the PLDs, thermal management techniques may need to be more dynamic than may be readily available for processors or ASICs.

### BRIEF DESCRIPTION OF THE DRAWINGS

Various aspects of this disclosure may be better understood upon reading the following detailed description and upon reference to the drawings in which:

Various aspects of this disclosure may be better understood upon reading the following detailed description and upon reference to the drawings in which:

FIG. 1 is a block diagram of a system that may implement logic-based operations using an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of a sectorized embodiment of the integrated circuit device of FIG. 1, in accordance with an embodiment of the present disclosure;

FIG. 4 is a flow diagram for controlling operation of the integrated circuit device of FIG. 1 based at least in part on thermal constraints, in accordance with an embodiment of the present disclosure;

FIG. 5 is a flow diagram for generating a configuration of the integrated circuit device of FIG. 1 based at least in part on thermal constraints, in accordance with an embodiment of the present disclosure; and

FIG. 6 is a data processing system, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Programmable logic devices (PLDs) may be programmable with various constraints, such as timing and power constraints. As discussed below, design software may work within the constraints to build a design that satisfies the timing constraints while trying to minimize power demands. For instance, when the design software is generating the design, it may balance the power and timing constraints while emphasizing one constraint (e.g., timing). Furthermore, since the various possible implementations may have different thermal impacts, the design software may further balance such thermal considerations when performing placement and routing determinations. As such, the design software may calculate, estimate, or follow rules related to thermal placement. For instance, when using back-side power to reduce/eliminate IR issues, the design software may factor in the heat dissipation issues for using such back-side power since the power delivery network may be buried below the active devices and located relatively closely to the insulator substrate. Moreover, the thermal considerations may include in-device thermal factors (e.g., placement of routes and circuitry used in the fabric), external thermal factors (e.g., placement of heat generating circuitry next to the device), heat sink placement, and/or any other factors that may impact temperature during operation of the PLD. Thus, such thermal aware design generation may be applicable to any PLD nodes rather than just nodes with back-side power.

Moreover, PLDs are increasingly permeating markets and are increasingly enabling customers to implement circuit designs in logic fabric (e.g., programmable logic) due to the large amount of flexibility provided by the PLDs. To provide this flexibility, a programmable logic fabric of an integrated circuit device may be programmed to implement a programmable circuit design to perform a wide range of functions and operations based on different designs or configurations loaded into the programmable fabric. The programmable logic fabric may include configurable blocks of programmable logic (e.g., sometimes referred to as logic array blocks (LABs) or configurable logic blocks (CLBs)) that have lookup tables (LUTs) that can be configured to operate as different logic elements based on the configuration programmed into memory cells in the blocks. However, this flexibility may cause a single constraint implementation (e.g., load line model) to be inappropriate across all of the different possible designs causing some devices to operate inefficiently and/or causing some devices to function improperly (e.g., due to overheating). Instead, custom/dynamic routing and/or operating voltages/frequencies/thermal profiles that are specific for the configuration of the programmable logic fabric and its thermal situation rather than the generic device may ensure efficient deployment for each customer/user/tenant based on their specific needs.

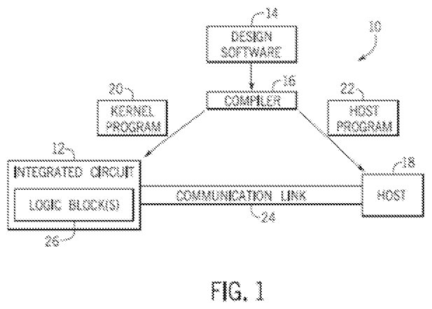

With the foregoing in mind, FIG. 1 illustrates a block diagram of a system 10 that may perform operations as described herein. A designer may desire to implement functionality, such as the operations of this disclosure, or an application involving operations on an integrated circuit device 12. The integrated circuit device 12 may be a PLD having a programmable logic fabric (such as a field programmable gate array (FPGA)). The programmable logic fabric may be implemented on a single monolithic die or multiple die arranged in a single package. For instance, multiple die may be arranged in a 2.5D configuration or a stacked 3D configuration. The integrated circuit device 12 may implement a programmable system design to carry out the desired functionality. In some cases, the designer may specify a high-level program, such as an OPENCL® program, which may enable the designer to more efficiently and easily provide programming instructions to configure a set of programmable logic cells for the integrated circuit device 12 without requiring specific knowledge of low-level hardware description languages (e.g., Verilog or VHDL). For example, because OPENCL® is quite similar to other high-level programming languages, such as C++, designers of programmable logic familiar with such programming languages may have a reduced learning curve than designers that may have to learn unfamiliar low-level hardware description languages to implement new functionalities in the integrated circuit device 12.

Designers may implement their high-level designs using design software 14, such as a version of INTEL® QUARTUS® by INTEL CORPORATION. The design software 14 may use a compiler 16 to convert the high-level program into a lower-level description. The design software 14 may also be used to optimize and/or increase efficiency in the design. The compiler 16 may provide machine-readable instructions representative of the high-level program to a host 18 and the integrated circuit device 12. The host 18 may receive a host program 22, which may be implemented by kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of one or more logic blocks 26 on the integrated circuit device 12. The logic block 26 may include circuitry and/or other logic elements and may be configured to implement arithmetic operations, such as addition and multiplication. The integrated circuit device 12 may include many (e.g., hundreds or thousands) of the logic blocks 26. Additionally, logic blocks 26 may be communicatively coupled to another such that data outputted from one logic block 25 may be provided to other logic blocks 26. The design software 14 and/or the compiler 16 may be implemented using any suitable memory and processor (e.g., CPU). For instance, the design software 14 and/or the compiler 16 may be run on the host 18 and/or any other computing devices suitable for executing design and compiling program applications.

The designer may use the design software 14 to generate and/or to specify a low-level program, such as the low-level hardware description languages described above. Further, in some embodiments, the system may be implemented without a separate host program. Moreover, in some embodiments, the techniques described herein may be implemented in circuitry as a non-programmable circuit design. Thus, embodiments described herein are intended to be illustrative and not limiting.

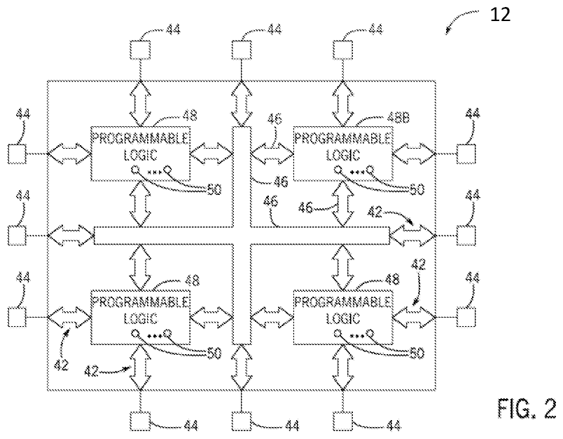

Turning now to a more detailed discussion of the integrated circuit device 12, FIG. 2 illustrates a block diagram of the integrated circuit device 12 that may be a programmable logic device, such as an FPGA. Further it should be understood that the integrated circuit device 12 may be any other suitable type of programmable logic device (e.g., an application-specific integrated circuit and/or application-specific standard product). Additionally or alternatively, the integrated circuit device 12 may be any suitable integrated circuit device. In certain embodiments, the integrated circuit device 12 may not be a programmable logic device. As shown, the integrated circuit device 12 may have input/output circuitry 42 for driving signals off device and for receiving signals from other devices via input/output pins 44. Interconnection resources 46, such as global and local vertical and horizontal conductive lines and buses, and/or configuration resources (e.g., hardwired couplings, logical couplings not implemented by user logic), may be used to route signals on the integrated circuit device 12. Additionally, interconnection resources 46 may include fixed interconnects (conductive lines) and programmable interconnects (i.e., programmable connections between respective fixed interconnects). Programmable logic 48 may include combinational and sequential logic circuitry. For example, programmable logic 48 may include look-up tables, registers, and multiplexers. In various embodiments, the programmable logic 48 may be configurable to perform a custom logic function. The programmable interconnects associated with interconnection resources may be considered to be a part of programmable logic 48. The programmable logic 48 may include multiple various types of programmable logic 48 of different tiers of programmability. For example, the programmable logic 48 may include various mathematical logic units, such as an arithmetic logic unit (ALU) or configurable logic block (CLB) that may be configurable to perform various mathematical functions (e.g., addition, multiplication, and so forth).

Programmable logic devices, such as integrated circuit device 12, may contain programmable elements 50, such as configuration random-access-memory (CRAM) cells loaded with configuration data during programming and look-up table random-access-memory (LUTRAM) cells that may store either configuration data or user data, within the programmable logic 48. The programmable elements 50 (e.g., CRAM cells) may be used to store one or more registers. For instance, a voltage identifier (VID) register may be allocated to the programmable elements 50 (e.g., CRAM cells) to store a code that corresponds to a voltage offset applied to the silicon of the programmable logic device used to ensure that the silicon meets both performance and power targets.

A designer (e.g., a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program programmable elements. In general, programmable elements 50 may be based on any suitable programmable technology, such as fuses, antifuses, electrically-programmable read-only-memory technology, random-access memory cells, mask-programmed elements, and so forth.

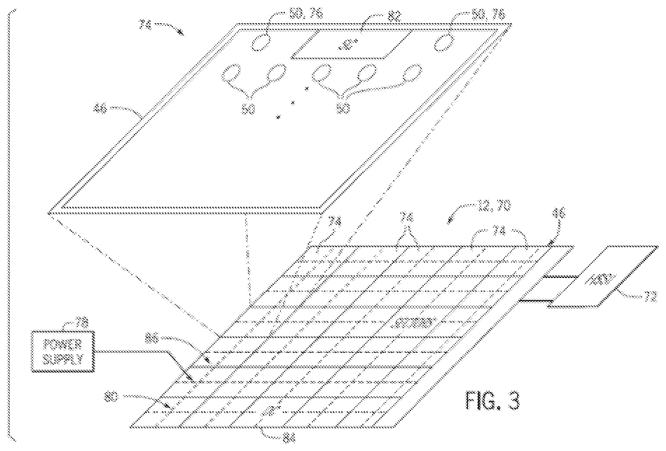

The integrated circuit device 12 may include any programmable logic device such as a field programmable gate array (FPGA) 70, as shown in FIG. 3. For the purposes of this example, the FPGA 70 is referred to as a FPGA, though it should be understood that the device may be any suitable type of programmable logic device (e.g., an application-specific integrated circuit and/or application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and Designer Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable elements 50 having operations defined by configuration memory 76 (e.g., CRAM). A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sector 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable element 50 or programmable component of the interconnection resources 46. The output signals of the configuration memory 76 may be applied to the gates of metal-oxide-semiconductor (MOS) transistors that control the states of the programmable elements 50 or programmable components of the interconnection resources 46.

The programmable elements 50 of the FPGA 40 may also include some signal metals (e.g., communication wires) to transfer a signal. In an embodiment, the programmable logic sectors 74 may be provided in the form of vertical routing channels (e.g., interconnects formed along a y-axis of the FPGA 70) and horizontal routing channels (e.g., interconnects formed along an x-axis of the FPGA 70), and each routing channel may include at least one track to route at least one communication wire. If desired, communication wires may be shorter than the entire length of the routing channel. That is, the communication wire may be shorter than the first die area or the second die area. A length L wire may span L routing channels. As such, a length of four wires in a horizontal routing channel may be referred to as “H4” wires, whereas a length of four wires in a vertical routing channel may be referred to as “V4” wires.

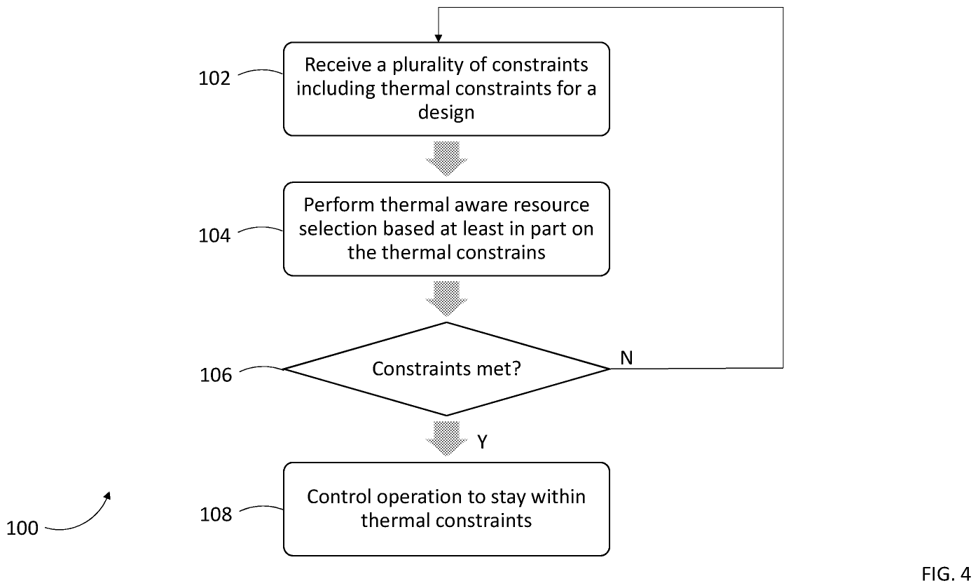

FIG. 4 is a flow chart of a process 100 for using thermal constraints to generate and implement design logic in the integrated circuit device 12. The process 100 may be implemented in hardware, software, or a combination of hardware and software. For instance, the design software 14 may be used to design a configuration for the programmable elements 50 that may be loaded and configured for the integrated circuit device 12. Based on this design, a power thermal calculator may determine the power consumption of the design and thermal conditions of the design. In some embodiments, the power thermal calculator may be implemented in the design software 14, may be implemented using software separate from the design software 14, and/or may be implemented using hardware. The process 100 includes receiving a plurality of constraints include thermal constraints (block 102). Receiving the plurality of constraints may be alongside receiving design configuration details for the configuration. Receiving the plurality of constraints may include the design software 14 receiving power constraints, thermal constraints, performance constraints (e.g., frequency constraints), and/or other constraints that may be placed on operations performed using the implementation. The power constraints may be the entire power budget for the integrated circuit device 12 and/or power budgets for sub-portions of the integrated circuit device 12 such as the implemented design or portions of the implemented design. The thermal constraints may include a temperature threshold for the entire integrated circuit device 12. Additionally or alternatively, the temperature thresholds may be specific to fine-grained portions (e.g., elements 50 or nodes) of the implemented design. Additionally or alternatively, at least some of the temperature thresholds may correspond to a region/sector/partition of the implemented design at a coarser level than element-specific thresholds. The thresholds may be associated with a specific thermal solution used in the implementation, such as types of packages, connections, or elements used. For instance, in some embodiments, these thresholds may be hard thresholds associated with the thermal solutions used while other “soft” thresholds (e.g., those input manually) may be set lower than the hard absolute maximum thresholds corresponding to the thermal solutions. Thus, the thresholds may be hard constraints/thresholds, soft constraints/thresholds, or a combination thereof. Furthermore, the constraints (e.g., thermal, power, performance) may be assigned priority levels that may be used in balancing the tradeoffs, such as limiting an implementation to DDR4 rather than DDR5 to limit transceiver speeds to reduce temperatures while reducing performance. These priority levels may be assigned based on severity. For example, a hard threshold risking potential damage above the threshold may be assigned the highest priority while power consumption or other temperature levels may be given lower priority levels. These priority levels may be assigned automatically based on selected resources in the design software 14, based on manual entry from a user via the design software 14, or a combination thereof.

The process 100 continues with performing thermal aware resource selection based at least in part on the thermal constraints (block 104). For instance, a processor implementing the design software 14 may perform resource selection based on the thermal constraints and/or thermal conditions of the design. Resource selection may include selecting features for a workload, such as choosing LPDDR5 or DDR5 based on the designated thermal constraints. Additionally or alternatively, selecting resources may include selecting placement of a resources, such as input/output (TO), various systems, routing, core implementations, and/or any other circuitry based on thermal considerations, such as estimated temperature of locations based on other planned circuitry in the PLD and/or in adjacent portions. For instance, at least some circuitry may be moved from the back-side due to thermal impacts due to heat dissipation issues since a power delivery network may be buried below the active devices and located relatively closely to the insulator substrate on the back-side. Moreover, the use of some circuitry (e.g., LABs) may be separated from each other with only a certain percentage (e.g., 60%) of those components (e.g., LABs) active to reduce density of heat generation. Additionally or alternatively, performing thermal aware resource selection includes performing power gating to stay within thermal limits established by the thermal constraints. For instance, certain numbers and/or locations of circuitry (e.g., LABs, ALUs, etc.) may be deactivated and power gated to cap heat generation. Additionally or alternatively, performing thermal aware resource selection may include performing clock gating to achieve a same maximum frequency with lower power and/or utilization. For instance, the maximum frequency may remain consistent, but circuitry (e.g., area/region/sector/partitions) of the integrated circuit device 12 may be turned off in a staggered manner so that fewer components are utilized at the same time.

The process 100 continues with determining whether constraints have been met (block 106). For instance, this determination may be made based on simulations, estimations, real-world testing, and/or other mechanisms for determining whether the constraints are met. In some embodiments, the determination may be made on a compiled output with the selected resources and their placements. In some embodiments, the determination includes requesting and/or receiving user approval of the compiled or uncompiled placements, resources, estimated thermal impacts, and/or other parameters. If the constraints are not met, new constraints may be requested and/or parameters may be adjusted to match the new/old constraints. Once the constraints have been met, the operations of the integrated circuit device 12 may be controlled to stay within the thermal constraints (block 108). For instance, controlling the operations of the integrated circuit device 12 may include throttling a frequency of the integrated circuit device 12 to allow the integrated circuit device 12 to operate within the thermal budget.

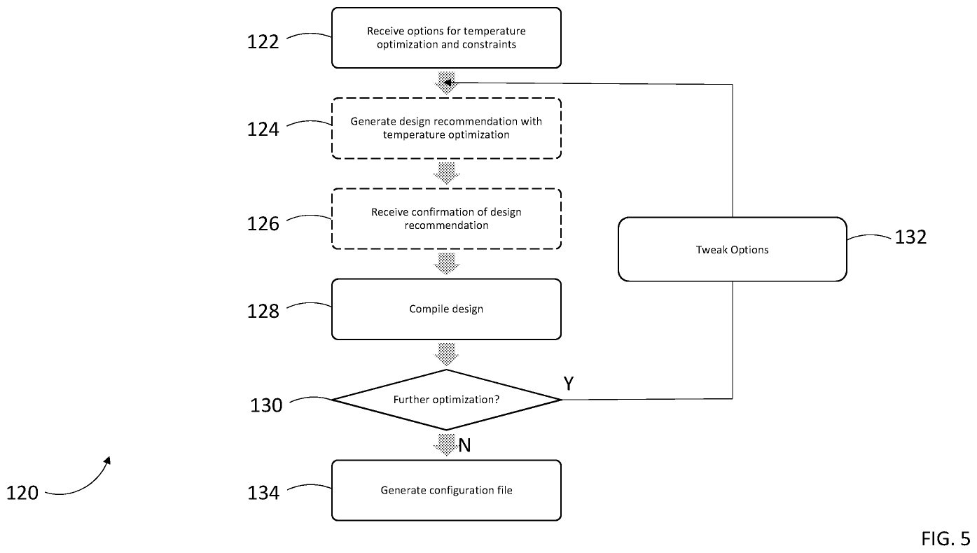

FIG. 5 is a block diagram of a process 120 that may be used for configuring the integrated circuit device 12. The process 120 may be implemented in hardware, software, or a combination of hardware and software. For instance, the design software 14 may be used to design a configuration for the programmable elements 50 that may be loaded and configured for the integrated circuit device 12. Based on this design, a power thermal calculator may determine the power consumption of the design and thermal conditions of the design. In some embodiments, the power thermal calculator may be implemented in the design software 14, may be implemented using software separate from the design software 14, and/or may be implemented using hardware.

The process 120 includes receiving options for temperature optimization and constraints (block 122). For instance, the design software 14 may request and/or receive options for optimizing temperature, such as performance tweaks/tradeoffs, IO/Subsystem placement, feature tradeoffs between lower performance/lower temperature (e.g., LPDDR5) and higher performance/higher temperature (e.g., DDR5), and/or any other factors/constraints previously discussed, such as thermal solutions, temperature thresholds, power budgets, and the like.

In some embodiments, the design software 14 may generate a design recommendation with temperature optimization based at least in part on the options (block 124). The design recommendation may indicate recommendations related to selected resources, resource placement, frequency settings, power gating, clock gating, and/or any of the previously discussed mechanisms for tweaking temperatures. In certain embodiments, the design software 14 may request and receive confirmation of the design recommendation (block 126) before compiling the design with such recommended values (block 128). For instance, the design software 14 requests confirmation via a display of the host computer and receives confirmation via input devices (e.g., mouse and/or keyboard) of the host computer. Additionally or alternatively, the design software 14 may use the recommended values for compilation without first requesting and/or receiving confirmation or approval of the recommended values.

The process continues with determining whether or not further optimization is to be performed (block 130). For instance, the design software 14 or another element may determine whether the constraints have been met. Additionally or alternatively, the design software 14 may request confirmation of the compiled design in place of or in addition to the confirmation of the design recommendation. For instance, additional information resulting from compile time analysis may be used to confirm additional constraints and/or request (original or supplemental) acceptance of the compiled design. If the constraints are not met or any other reason for further optimization exists, at least one of the thermal optimization options are tweaked (block 132), and eventually the tweaked design is recompiled. Once no further optimization is to be performed, the design software 14 generates a configuration file (block 134) that is loaded into the integrated circuit device 12 such as in CRAM from which the configuration is loaded into the programmable fabric of the integrated circuit device. As previously noted, the configuration file may include control mechanisms that enable a processor, such as a host device or logic implemented in the circuitry (e.g., hardened circuitry and/or in the programmable fabric) of the integrated circuit device 12, to enable a change in maximum frequency and/or other parameters of the integrated circuit device 12 if operations cause thermal properties to exceed the thermal constraints. As previously noted, in some embodiments, additional constraints, such as voltage may be considered along with the temperature considerations. For instance, thermal constraints may be used along with the voltage in the techniques disclosed in U.S. Patent Publication No. 2022/0335190, entitled “Dynamic Power Load Line by Configuration,” which is incorporated in its entirety.

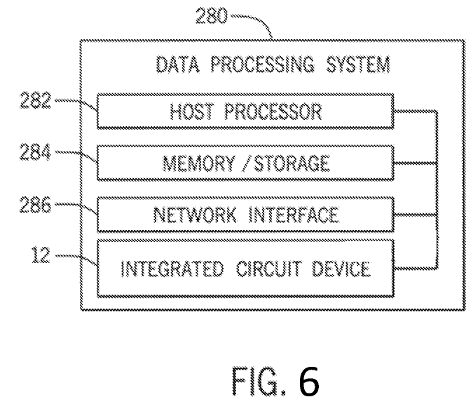

The integrated circuit device 12 may be a data processing system or a component included in a data processing system. For example, the integrated circuit device 12 may be a component of a data processing system 280 shown in FIG. 6. The data processing system 280 may include a host processor 282 (e.g., a central-processing unit (CPU)), memory and/or storage circuitry 284, and a network interface 286. The data processing system 280 may include more or fewer components (e.g., electronic display, user interface structures, application specific integrated circuits (ASICs)). The host processor 282 may include any suitable processor, such as an INTEL® Xeon® processor or a reduced-instruction processor (e.g., a reduced instruction set computer (RISC), an Advanced RISC Machine (ARM) processor) that may manage a data processing request for the data processing system 280 (e.g., to perform debugging, data analysis, encryption, decryption, machine learning, video processing, voice recognition, image recognition, data compression, database search ranking, bioinformatics, network security pattern identification, spatial navigation, or the like). The memory and/or storage circuitry 284 may include random access memory (RAM), read-only memory (ROM), one or more hard drives, flash memory, or the like. The memory and/or storage circuitry 284 may hold data to be processed by the data processing system 280. In some cases, the memory and/or storage circuitry 284 may also store configuration programs (bitstreams) for programming the integrated circuit device 12. Additionally, as previously noted, the integrated circuit device 12 used to store the VID value used to indicate the voltage that will be used to supply to the silicon of the integrated circuit device. The network interface 286 may allow the data processing system 280 to communicate with other electronic devices. The data processing system 280 may include several different packages or may be contained within a single package on a single package substrate.

In one example, the data processing system 280 may be part of a data center that processes a variety of different requests. For instance, the data processing system 280 may receive a data processing request via the network interface 286 to perform acceleration, debugging, error detection, data analysis, encryption, decryption, machine learning, video processing, voice recognition, image recognition, data compression, database search ranking, bioinformatics, network security pattern identification, spatial navigation, digital signal processing, or some other specialized task.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A system comprising:
memory storing instructions;
a processor, that when executing the instructions, performs operations comprising:
implementing design software that is used to design a configuration for a programmable fabric of a programmable logic device, wherein implementing the design software comprises:
receiving, at the processor, design configuration details for the configuration;
receiving, at the processor, a plurality of constraints comprising a thermal constraint for the configuration;
performing thermal aware resource selection based at least in part on the thermal constraints; and
causing the programmable logic device to be operated to stay within the thermal constraints.

EXAMPLE EMBODIMENT 2. The system of example embodiment 1, wherein a power thermal calculator determines thermal conditions and power consumption of the programmable logic device.

EXAMPLE EMBODIMENT 3. The system of example embodiment 2, wherein the processor also implements the power thermal calculator.

EXAMPLE EMBODIMENT 4. The system of example embodiment 2, wherein the power thermal calculator receives design configuration parameters from the design software and determines heat generation from the configuration parameters.

EXAMPLE EMBODIMENT 5. The system of example embodiment 1, wherein the plurality of constraints comprises power constraints, performance constraints, or a plurality thereof.

EXAMPLE EMBODIMENT 6. The system of example embodiment 1, wherein the thermal constraints comprise a maximum temperature threshold.

EXAMPLE EMBODIMENT 7. The system of example embodiment 6, wherein the maximum temperature threshold comprises a device temperature threshold for an entirety of the programmable logic device, a region temperature threshold for a region of the programmable fabric, a sector temperature threshold for a sector of the programmable logic fabric, a partition temperature threshold for a partition of the programmable logic fabric, or a combination thereof.

EXAMPLE EMBODIMENT 8. The system of example embodiment 1, wherein resource selection comprises selecting types of circuitry to be included for a workload based at least in part on the thermal constraint.

EXAMPLE EMBODIMENT 9. The system of example embodiment 1, wherein resource selection comprises determining locations for placement of resources based at least in part on the thermal constraint.

EXAMPLE EMBODIMENT 10. The system of example embodiment 1, wherein the programmable logic device comprises a single monolithic die.

EXAMPLE EMBODIMENT 11. The system of example embodiment 1, wherein the programmable logic device comprises multiple die in a 2.5D or a stacked 3D configuration.

EXAMPLE EMBODIMENT 12. A method comprising:
receiving options for temperature optimization for a design configuration for programmable fabric of a programmable logic device;
receiving constraints for the design configuration, wherein the constraints comprise a thermal constraint;
generating a design based on the temperature optimization;
compiling the design to generate a compiled design;
determining that the constraints have been met by the compiled design; and
generating a configuration file and loading the configuration file onto the programmable logic device.

EXAMPLE EMBODIMENT 13. The method of example embodiment 12, wherein generating the design comprises power gating circuitry of the programmable logic device based at least in part on the temperature optimization or the constraints.

EXAMPLE EMBODIMENT 14. The method of example embodiment 12, wherein generating the design comprises causing clock gating to stagger utilization of circuitry based at least in part on the temperature optimization of the constraints.

EXAMPLE EMBODIMENT 15. The method of example embodiment 12, wherein generating the design comprises:
generating a design recommendation based at least in part on the temperature optimization and constraints;
receiving a confirmation of the design recommendation; and
generating the design from the design recommendation.

EXAMPLE EMBODIMENT 16. The method of example embodiment 12, wherein generating the design comprising:
selecting resources to be used in the design based at least in part on the temperature optimization or constraints; or
placing resources in locations selected at least in part based on the temperature optimization or constraints.

EXAMPLE EMBODIMENT 17. The method of example embodiment 12, comprising:
generating a previous design before the design;
determining that the previous design does not meet the constraints; and
tweaking the options or constraints for use in generating the design.

EXAMPLE EMBODIMENT 18. A tangible, non-transitory, and computer-readable medium having stored thereon instructions, that when executed by a processor, causes the processor to:
receive a plurality of constraints for a configuration of a programmable logic device, wherein the plurality of constraints comprises a thermal constraint for the programmable logic device;
perform thermal aware resource selection based at least in part on the thermal constraint; and
when the plurality of constraints is met, cause the programmable logic device to be operated to stay within the thermal constraint by loading the configuration into the programmable logic device with instructions to stay within the thermal constraint.

EXAMPLE EMBODIMENT 19. The tangible, non-transitory, and computer-readable medium of example embodiment 18, wherein the instructions, when executed, cause the processor to receive design specifications for the configuration of the programmable logic device along with the thermal constraint.

EXAMPLE EMBODIMENT 20. The tangible, non-transitory, and computer-readable medium of example embodiment 18, wherein the instructions to stay within the thermal constraint causes a frequency throttling operation when the thermal constraint is exceeded during operation.

What is claimed is:

1. A system comprising:
memory storing instructions;
a processor, that when executing the instructions, performs operations comprising:
implementing design software that is used to design a configuration for a programmable fabric of a programmable logic device, wherein implementing the design software comprises:
receiving, at the processor, design configuration details for the configuration;
receiving, at the processor, a plurality of constraints comprising a thermal constraint for the configuration;
performing thermal aware resource selection based at least in part on the thermal constraint; and
causing the programmable logic device to be operated to stay within the thermal constraint.

2. The system of claim 1, wherein a power thermal calculator determines thermal conditions and power consumption of the programmable logic device.

3. The system of claim 2, wherein the processor also implements the power thermal calculator.

4. The system of claim 2, wherein the power thermal calculator receives design configuration parameters from the design software and determines heat generation from the configuration parameters.

5. The system of claim 1, wherein the plurality of constraints comprises power constraints, performance constraints, or a plurality thereof.

6. The system of claim 1, wherein the thermal constraint comprises a maximum temperature threshold.

7. The system of claim 6, wherein the maximum temperature threshold comprises a device temperature threshold for an entirety of the programmable logic device, a region temperature threshold for a region of the programmable fabric, a sector temperature threshold for a sector of the programmable fabric, a partition temperature threshold for a partition of the programmable fabric, or a combination thereof.

8. The system of claim 1, wherein the thermal aware resource selection comprises selecting types of circuitry to be included for a workload based at least in part on the thermal constraint.

9. The system of claim 1, wherein the thermal aware resource selection comprises determining locations for placement of resources based at least in part on the thermal constraint.

10. The system of claim 1, wherein the programmable logic device comprises a single monolithic die.

11. The system of claim 1, wherein the programmable logic device comprises multiple die in a 2.5D or a stacked 3D configuration.

12. A method comprising:
receiving options for temperature optimization for a design configuration for programmable fabric of a programmable logic device;
receiving constraints for the design configuration, wherein the constraints comprise a thermal constraint;
generating a design based on the temperature optimization;
compiling the design to generate a compiled design;
determining that the constraints have been met by the compiled design; and
generating a configuration file and loading the configuration file onto the programmable logic device.

13. The method of claim 12, wherein generating the design comprises power gating circuitry of the programmable logic device based at least in part on the temperature optimization or the constraints.

14. The method of claim 12, wherein generating the design comprises causing clock gating to stagger utilization of circuitry based at least in part on the temperature optimization or the constraints.

15. The method of claim 12, wherein generating the design comprises:
generating a design recommendation based at least in part on the temperature optimization and the constraints;
receiving a confirmation of the design recommendation; and
generating the design from the design recommendation.

16. The method of claim 12, wherein generating the design comprises:
selecting resources to be used in the design based at least in part on the temperature optimization or the constraints; or
placing resources in locations selected at least in part based on the temperature optimization or the constraints.

17. The method of claim 12, comprising:
generating a previous design before the design;
determining that the previous design does not meet the constraints; and
tweaking the options or the constraints for use in generating the design.

18. A tangible, non-transitory, and computer-readable medium having stored thereon instructions, that when executed by a processor, cause the processor to:
receive a plurality of constraints for a configuration of a programmable logic device, wherein the plurality of constraints comprise a thermal constraint for the programmable logic device;
perform thermal aware resource selection based at least in part on the thermal constraint; and
when the plurality of constraints is met, cause the programmable logic device to be operated to stay within the thermal constraint by loading the configuration into the programmable logic device with instructions to stay within the thermal constraint.

19. The tangible, non-transitory, and computer-readable medium of claim 18, wherein the instructions, when executed, cause the processor to receive design specifications for the configuration of the programmable logic device along with the thermal constraint.

20. The tangible, non-transitory, and computer-readable medium of claim 18, wherein the instructions to stay within the thermal constraint cause a frequency throttling operation when the thermal constraint is exceeded during operation.
